(19) United States
(12) Patent Application Publication
(10) Pub. No.: US 2020/0318976 A1
(43) Pub. Date: Oct. 8, 2020

(54) METHODS AND SYSTEMS FOR MAPPING AND LOCALIZATION FOR A VEHICLE

(71) Applicant: GM GLOBAL TECHNOLOGY OPERATIONS LLC, Detroit, MI (US)

(72) Inventors: Lawrence A. Bush, Shelby Township, MI (US); Michael A. Losh, Rochester Hills, MI (US); Brent N. Bacchus, Sterling Heights, MI (US); Upali P. Mudalige, Oakland Township, MI (US)

(73) Assignee: GM GLOBAL TECHNOLOGY OPERATIONS LLC, Detroit, MI (US)

(21) Appl. No.: 16/373,663

(22) Filed: Apr. 3, 2019

(51) Int. Cl. G01C 21/32; G05D 1/02

(52) U.S. Cl. CPC G01C 21/32; G05D 2201/0213; G05D 1/0246; G05D 1/0274

(57) ABSTRACT

Systems and methods are provided for controlling a vehicle. In one embodiment, a method includes: receiving, by a processor, landmark data obtained from an image sensor of the vehicle; fusing, by the processor, the landmark data with vehicle pose data to produce fused lane data, wherein the fusing is based on a Kalman filter; retrieving, by the processor, map data from a lane map based on the vehicle pose data; selectively updating, by the processor, the lane map based on a change in the fused lane data from the map data; and controlling, by the processor, the vehicle based on the updated lane map.

### INTRODUCTION

The present disclosure generally relates to vehicles, and more particularly relates to methods and systems for managing low definition map information and localization information for use in controlling a vehicle.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

While autonomous vehicles and semi-autonomous vehicles offer many potential advantages over traditional vehicles, in certain circumstances it may be desirable for improved operation of the vehicles. For example, autonomous vehicles determine their location, for example, within the environment and in particular within lane boundaries (referred to herein as localization) and use that location to navigate the vehicle. Autonomous vehicles determine their location based on maps of the environment. Some maps are generated from data received from a lidar. Lidars can be expensive and are not optimum in severe weather conditions. Some maps, not generated by lidar, are considered low definition maps and include lane only information. Such maps may not be entirely accurate.

Accordingly, it is desirable to provide improved systems and methods for generating maps and localizing a vehicle. It is further desirable to provide improved systems and method for mapping and localizing the vehicle based on the low definition maps which are less costly to produce. Furthermore, other desirable features and characteristics of the present disclosure will become apparent from the subsequent detailed description and the appended claims, taken in conjunction with the accompanying drawings and the foregoing technical field and background.

### SUMMARY

Systems and methods are provided for controlling a vehicle. In one embodiment, a method includes: receiving, by a processor, landmark data obtained from an image sensor of the vehicle; fusing, by the processor, the landmark data with vehicle pose data to produce fused lane data, wherein the fusing is based on a Kalman filter; retrieving, by the processor, map data from a lane map based on the vehicle pose data; selectively updating, by the processor, the lane map based on a change in the fused lane data from the map data; and controlling, by the processor, the vehicle based on the updated lane map.

In various embodiments, the fused lane data includes a right lane edge and a left lane edge, and wherein the selectively updating comprises selectively updating a right lane edge and a left lane edge of the lane map based on the right lane edge and the left lane edge of the fused lane data. In various embodiments, the selectively updating comprises: replacing the right lane edge and the left lane edge when the change is greater than a threshold; and fusing the right lane edge and the left lane edge of the lane data with the right lane edge and the left lane edge of the lane map when the change is less than the threshold. In various embodiments, the computing the change is based on a hypothesis test. In various embodiments, the computing the change is based on a Mahalanobis distance.

In various embodiments, the fused lane data includes a position of a center of the lane, and wherein the method further comprises correcting the vehicle pose data based on the map data and the position of the center of the lane.

In various embodiments, the landmark data includes lane markings along the road. In various embodiments, the landmark data includes lane edges inferred from image data. In various embodiments, the landmark data includes structures identified next to a lane edge.

In another embodiment, a system includes at least one image sensor that generates image data associated with an environment of the vehicle; a map datastore that stores a lane map; and a controller configured to, by a processor, receive landmark data obtained from an image sensor of the vehicle, fuse the landmark data with vehicle pose data to produce fused lane data, wherein the fusing is based on a Kalman filter, retrieve map data from the lane map based on the vehicle pose data, selectively updates the lane map based on a change in the fused lane data from the map data; and controls the vehicle based on the updated lane map.

In various embodiments, the fused lane data includes a right lane edge and a left lane edge, and wherein the selectively updating comprises selectively updating a right lane edge and a left lane edge of the lane map based on the right lane edge and the left lane edge of the fused lane data.

In various embodiments, the controller selectively updates by replacing the right lane edge and the left lane edge when the change is greater than a threshold; and fusing the right lane edge and the left lane edge of the lane data with the right lane edge and the left lane edge of the lane map when the change is less than the threshold.

In various embodiments, the controller computes the change based on a hypothesis test. In various embodiments, the controller computes the change based on a Mahalanobis distance.

In various embodiments, the fused lane data includes a position of a center of the lane, and wherein the controller corrects the vehicle pose data based on the map data and the position of the center of the lane.

In various embodiments, the landmark data includes lane markings along the road. In various embodiments, the landmark data includes lane edges inferred from image data.

In various embodiments, the landmark data includes structures identified next to a lane edge. In various embodiments, the controller continuously updates the map during operation of the vehicle.

In various embodiments, controller generates map error data for graphically displaying the error on the lane map to a user.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a mapping and localization system, in accordance with various embodiments;

FIG. 2 is a dataflow diagrams illustrating an autonomous driving system that includes the mapping and localization system, in accordance with various embodiments;

FIG. 3 is a dataflow diagram illustrating an updating system of the mapping and localization system, in accordance with various embodiments;

FIGS. 4 and 5 are flowcharts illustrating methods that may be performed by the mapping and localization system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

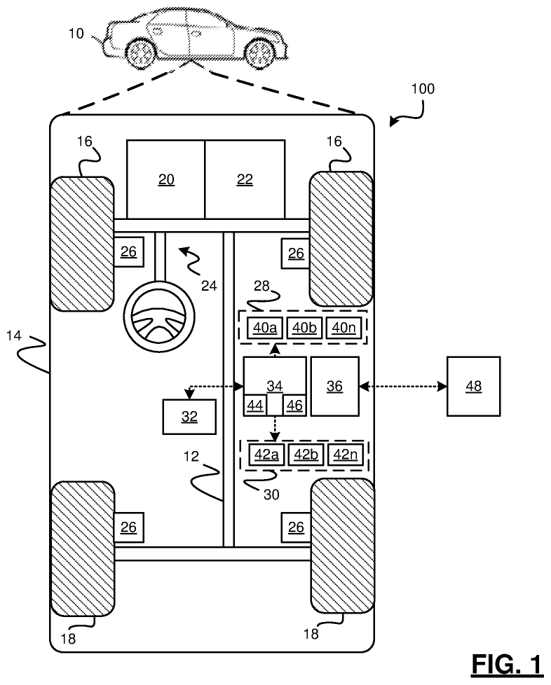

With reference to FIG. 1, a mapping and localization system shown generally at 100 is associated with a vehicle 10 in accordance with various embodiments. In general, the mapping and localization system 100 processes data provided by one or more sensors disposed about the vehicle 10 (as will be discussed in more detail below) along with data from a low definition map to update a map of the environment. The mapping and localization system 100 then uses the map to localize the vehicle 10 as the vehicle travels. The vehicle 10 then intelligently navigates based on the outputs of the mapping and localization system 100.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the localization system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, or simply robots, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. As can be appreciated, in various embodiments, the autonomous vehicle 10 can be any level of automation.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. In various embodiments, the sensing devices 40a-40n include one or more image sensors that generate image sensor data that is used by the mapping and localization system 100. In various embodiments, the sensing devices 40a-40n sense one or more observable conditions of the vehicle 10. Such sensors can include, but are not limited to, odometers, speed sensors, inertial measurement units (IMU), global position systems (GPS), etc.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

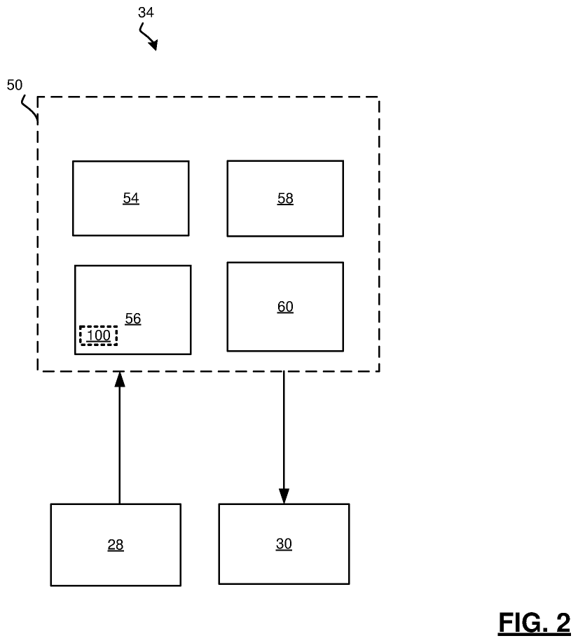

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps include low definition maps that are used by and/or generated from the mapping and localization system 100. In various embodiments, some of the maps are received from a remote system and/or other vehicles. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. In various embodiments, one or more instructions of the controller 34 are embodied in the mapping and localization systems 100 and methods 200, 300 described herein.

In accordance with various embodiments, the controller 34 implements an autonomous driving system (ADS) 50 as shown in FIG. 2. That is, suitable software and/or hardware components of the controller 34 (e.g., the processor 44 and the computer-readable storage device 46) are utilized to provide an autonomous driving system 50 that is used in conjunction with vehicle 10.

In various embodiments, the instructions of the autonomous driving system 50 may be organized by function, module, or system. For example, as shown in FIG. 2, the autonomous driving system 50 can include a computer vision system 54, a positioning system 56, a guidance system 58, and a vehicle control system 60. As can be appreciated, in various embodiments, the instructions may be organized into any number of systems (e.g., combined, further partitioned, etc.) as the disclosure is not limited to the present examples.

In various embodiments, the computer vision system 54 synthesizes and processes sensor data and predicts the presence, location, classification, and/or path of objects and features of the environment of the vehicle 10. In various embodiments, the computer vision system 54 can incorporate information from multiple sensors, including but not limited to cameras, lidars, radars, and/or any number of other types of sensors.

The positioning system 56 processes sensor data along with other data to determine a position (e.g., a local position relative to a map, an exact position relative to lane of a road, vehicle heading, velocity, etc.) of the vehicle 10 relative to the environment. The guidance system 58 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, the mapping and localization system 100 of FIG. 1 may be included within the ADS 50, for example, as part of the positioning system 56. In such embodiments, the mapping and localization system 100 provides maps and localization data to the positioning system 56 indicating a location of the vehicle 10 for use in navigation.

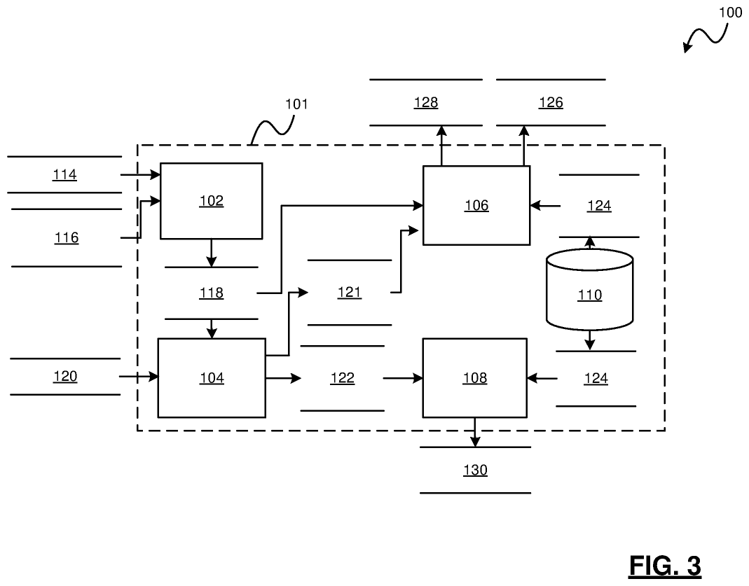

As shown in more detail with regard to FIG. 3 and with continued reference to FIGS. 1 and 2, the mapping and localization system 100 includes an updating system 101. The updating system 101 may be implemented as one or more modules and/or sub-modules. As can be appreciated, the modules shown may be combined and/or further partitioned in various embodiments. The updating system 101 includes a global pose determination module 102, a landmark fusion module 104, a pose correction module 106, a map correction module 108, and a map datastore 110.

The global pose determination module 102 receives as input position data 114 and odometer/IMU data 116. The position data 114 indicates a global position of the vehicle 10 and can be received from the GPS or other positioning system. The odometer/IMU data 116 indicates a determined pose of the vehicle 10 including a direction and a longitudinal speed of the vehicle 10.

The global pose determination module 102 determines global pose data 118 of the vehicle 10 by fusing the position data 114 and the odometer data 116. For example, the global pose determination module 116 uses a Kalman filter (EKF, UKF, etc.) to fuse the data 114, 116. The output of the fusion includes a global speed, a global heading, and a global position of the vehicle 10 which are collectively referred to as the global pose data 118.

The landmark fusion module 104 receives as input the global pose data 118, and landmark data 120. The landmark data 120 can be received from a camera or other imaging devices of the vehicle 10. The landmark data 120 indicates a sensed position (according to a coordinate system of the vehicle 10) of identified landmarks such as lane markings, signs or other structures by the lane edges, free space, etc. along the road that may indicate a lane edge. In various embodiments, the landmark data 120 may be preprocessed and include lane edge information that has been inferred from the characteristics identified in the image data 120 or from other data. For exemplary purposes, the embodiments described below refer to lane markings as the landmark data 120. As can be appreciated, other landmarks can be similarly implemented to determine the lane edges.

The landmark fusion module 104 estimates global lane edges 122 by fusing the global pose data 118 with the landmark data 120. For example, the landmark fusion module 104 uses a Kalman filter to fuse the data over time. The output of the fusion includes a position of the left lane edge and a position of the right lane edge in a global coordinate system, and an uncertainty of each of the positions, which are collectively referred to as the global lane edge data 122. The output of the fusion further includes a position of the center of the lane in a global coordinate system, which is referred to as a global lane center data 121.

The pose correction module 106 receives as input the global pose data 118, and the global lane center data 121. The pose correction module 106 obtains lane data 124 from a low definition map stored in the map datastore 110. The lane data 124 includes positions of the right lane, the left lane, and the center of the lane. The pose correction module 106 determines any discrepancies between the lane data 124 from the map and the global lane center data 121. The pose correction module 106 corrects the global pose data 118 based on the discrepancies to produce a corrected pose 128 that may be used, for example, by the ADS 50.

The pose correction module determines the discrepancies based on a magnitude of the difference between the global lane center data 121 and the map lane data 124. The pose correction module 106 makes available the discrepancies as map error data 126 for use in controlling the vehicle 10.

The map correction module 108 receives the global lane edge data 122, and map lane data 124. The map correction module 108 continuously updates lane edge information stored in the map based on the global lane edge data 122. In various embodiments, the map correction module 10 updates the map by fusing the global lane edge data 122 with the map lane data 124. In various embodiments, when the changes to map are drastic, the map correction module 108 updates the map by replacing the map lane data with the global lane edge data 122 (i.e., instead of fusing the data). The changes to the map can be presented graphically to a user of the vehicle 10 or may be used to navigate the vehicle 10.

In various embodiments, the map correction module 108 determines whether the changes are drastic based on a hypotheses test that compares the likelihood that the new data comes from a distribution described by the map (null hypothesis Ho) versus from a different distribution (alternate hypothesis Hi). In various embodiments, the map correction module 108 determines whether the changes are drastic based on a Mahalanobis distance between the map information and the global lane information. In such embodiments, the threshold may be determined from an extreme value distribution from n distances using a Gumbel distribution. As can be appreciated, other methods for determining whether the changes are drastic may be implemented in various embodiments.

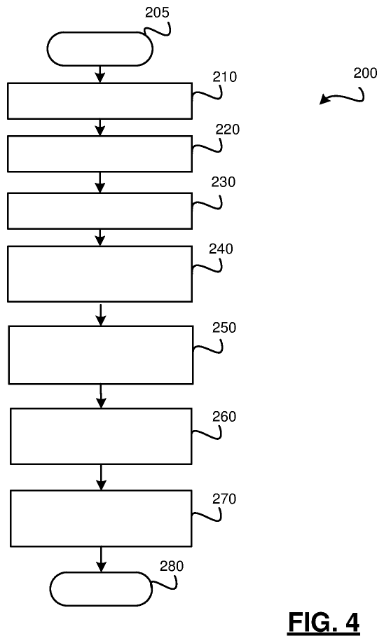

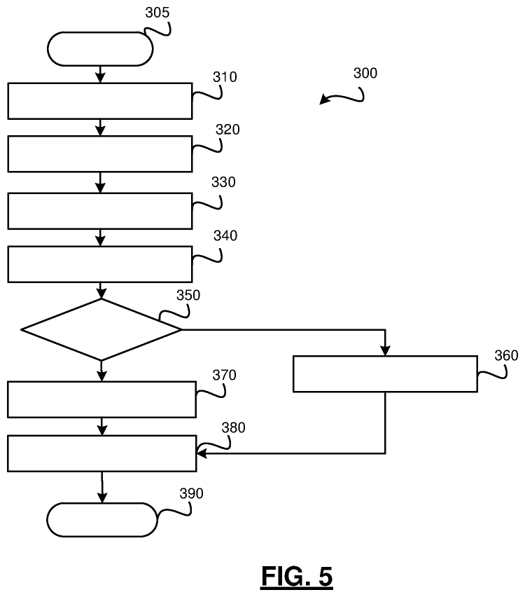

With reference now to FIGS. 4 and 5 and with continued reference to FIGS. 1-3, flowcharts illustrate methods 200, 300 that can be performed by the system 100 in accordance with various embodiments. As can be appreciated, in light of the disclosure, the order of operation within the methods 200, 300 is not limited to the sequential execution as illustrated in FIGS. 4 and 5 but may be performed in one or more varying orders as applicable and in accordance with the present disclosure. In various embodiments, the methods 200, 300 can be scheduled to run based on one or more predetermined events, and/or can run continuously during operation of the autonomous vehicle 10.

FIG. 4 illustrates an exemplary method 200 for fusing data, such as fusing to obtain the global lane edge data 122. As can be appreciated, the same or similar fusing method may be used for other fusing. In one example, the method may begin at 200. The image data 120 and the global pose data 118 are received at 210. In various embodiments, the image data 120 includes a polynomial representation of the landmarks indicating a lane edge according to a host vehicle (HV) frame: y=a₀+a₁x+a₂x²+ . . . , where x is the longitudinal distance and y is the lateral distance. The lane distances from the image data 120 are then converted to a lane frame (e.g., when the vehicle 10 is not parallel to the lane edge) at 220 using d−=a₀ cos δ, where δ=tan⁻¹ a₁ and d is the lateral distance to the vehicle 10 from the lane edge. Similarly, the longitudinal speed from the global pose data 118 is converted to the lane frame at 230 using: v=v′ cos δ, where v′ is the longitudinal speed in the host vehicle frame and v is the longitudinal speed in the lane frame.

The lane distances and the longitudinal speed are processed with a Kalman filter at 240 using a process model:

$$( \begin{matrix}{w}_{t + 1} \\ {c}_{t + 1}\end{matrix} ) = ( \begin{matrix}{e}^{- \frac{v Δ T}{D}} & 0 \\ 0 & {e}^{- \frac{v Δ T}{D}}\end{matrix} ) ( \begin{matrix}{w}_{t} \\ {c}_{t}\end{matrix} ) + ( \begin{matrix}{w}_{0} ( 1 - {e}^{- \frac{v Δ T}{D}} ) \\ 0\end{matrix} ) .$$

Where c represents the signed offset from the center of the lane, w represents the width of the lane, constant D determines converge rate to nominal, ΔT is a sample period, v represents the longitudinal speed of the vehicle in the lane frame, and w0 represents a nominal road width (e.g., 3.7 m).

A process covariance:

$$Q = ( \begin{matrix}{σ}_{w}^{2} & 0 \\ 0 & {σ}_{c}^{2}\end{matrix} )$$

where σ_{w}² and σ_{c}² are variances tuned beforehand.

An Observation model:

$$( \begin{matrix}{d}_{l} \\ {d}_{r}\end{matrix} ) = ( \begin{matrix}- 0.5 & 1 \\ 0.5 & 1\end{matrix} ) ( \begin{matrix}{w}_{t} \\ {c}_{t}\end{matrix} )$$

Where dₗ represents the lateral distance from the left lane edge to the host vehicle and dᵣ represents the lateral distance from the right lane edge to the host vehicle.

An Observation covariance:

$$R = ( \begin{matrix}{σ}_{l}^{2} & 0 \\ 0 & {σ}_{r}^{2}\end{matrix} )$$

Where σₗ² represents the left distance variance and σᵣ² represents the right distance variance, which are derived from the sensor. As can be appreciated, these values may be predefined if the sensor does not provide the information (e.g. using look up table).

Thereafter, at 250, the fused lane center offset and the width are converted to lateral left and right distances in the lane frame using:

$$( \begin{matrix}{d}_{l} \\ {d}_{r}\end{matrix} ) = ( \begin{matrix}- 0.5 & 1 \\ 0.5 & 1\end{matrix} ) ( \begin{matrix}{w}_{t} \\ {c}_{t}\end{matrix} )$$

The distances are converted to the host vehicle frame using:

$${( \begin{matrix}x \\ y\end{matrix} )}_{l}^{HV} = ( \begin{matrix}cos δ & 0 \\ 0 & sin δ\end{matrix} ) ( \begin{matrix}{d}_{l} \\ {d}_{l}\end{matrix} )$$

$${( \begin{matrix}x \\ y\end{matrix} )}_{r}^{HV} = ( \begin{matrix}cos δ & 0 \\ 0 & sin δ\end{matrix} ) ( \begin{matrix}{d}_{r} \\ {d}_{r}\end{matrix} )$$

Where

$${( \begin{matrix}x \\ y\end{matrix} )}_{l} and {( \begin{matrix}x \\ y\end{matrix} )}_{r}$$

are left and right Cartesian coordinates, respectively.

The coordinates are converted to the global frame using the host vehicle heading and the position from the global pose data 118 at 260 using:

$${( \begin{matrix}x \\ y\end{matrix} )}_{l} = {( \begin{matrix}x \\ y\end{matrix} )}^{GPS} + R ( θ ) {( \begin{matrix}x \\ y\end{matrix} )}_{l}^{HV}$$

$${( \begin{matrix}x \\ y\end{matrix} )}_{r} = {( \begin{matrix}x \\ y\end{matrix} )}^{GPS} + R ( θ ) {( \begin{matrix}x \\ y\end{matrix} )}_{r}^{HV}$$

Where θ is the host vehicle heading and

$$R ( θ ) = ( \begin{matrix}cos θ & - sin θ \\ sin θ & cos θ\end{matrix} )$$

is a rotation matrix.

The resulting vectors

$${( \begin{matrix}x \\ y\end{matrix} )}_{l} and {( \begin{matrix}x \\ y\end{matrix} )}_{r}$$

give final coordinates of the left and right lane edges.

The covariance of each vector is then given at 270 using:

Σₗ=Σ^{GPS}+HₗPₗHₗ^{T}

Σᵣ=Σ^{GPS}+HᵣPᵣHᵣ^{T}

$${H}_{l} = R ( θ ) ( \begin{matrix}sin δ \\ cos δ\end{matrix} ) \begin{matrix}( - 0.5 & 1 )\end{matrix}$$

$${H}_{r} = R ( θ ) ( \begin{matrix}sin δ \\ cos δ\end{matrix} ) ( \begin{matrix}0.5 & 1 )\end{matrix}$$

Where Σ^{GPS} is the HV position covariance, Pₗ and Pᵣ are left and right process covariances.

Thereafter, the method of fusing the lane edge information may end at 280.

As can be appreciated, other methods and computations may be implemented in various other embodiments.

FIG. 5 illustrates an exemplary method 300 for correcting a pose of the vehicle 10 and updating the map. In one example, the method 300 may begin at 305. Data 114-116, 120 is collected from the sensor system 28, such as, from the camera, the IMU, the odometer, the GPS, etc. The global pose data 118 is determined based on the position data 114 and the odometer/IMU data 116 at 310. The global lane edge data 122 is determined based on the global pose data 118 and the landmark data 120 at 320, for example, as discussed with regard to FIG. 4.

Thereafter, the vehicle pose is corrected based on the map lane data 124, the global lane center data 121, and the global pose data 118 at 330 and the map error 126 is produced based thereon at 340. The changes are then determined and compared to a threshold at 350 to see if they are drastic. When the map error 126 exceeds the threshold at 350 (drastic), the map edges are replaced with the fused lane edges at 360 and the map is updated at 380. When the map error 126 does not exceed the threshold at 350 (not drastic), the global lane edges are fused with the map lane edges using, for example, techniques described with regard to FIG. 4 at 370 and the map is updated at 380. Thereafter, the method may end at 90.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling a vehicle, comprising:
receiving, by a processor, landmark data obtained from an image sensor of the vehicle;
fusing, by the processor, the landmark data with vehicle pose data to produce fused lane data, wherein the fusing is based on a Kalman filter;
retrieving, by the processor, map data from a lane map based on the vehicle pose data;
selectively updating, by the processor, the lane map based on a change in the fused lane data from the map data; and
controlling, by the processor, the vehicle based on the updated lane map.

2. The method of claim 1, wherein the fused lane data includes a right lane edge and a left lane edge, and wherein the selectively updating comprises selectively updating a right lane edge and a left lane edge of the lane map based on the right lane edge and the left lane edge of the fused lane data.

3. The method of claim 2, wherein the selectively updating comprises:
replacing the right lane edge and the left lane edge when the change is greater than a threshold; and fusing the right lane edge and the left lane edge of the lane data with the right lane edge and the left lane edge of the lane map when the change is less than the threshold.

4. The method of claim 3, further comprising computing the change based on a hypothesis test.

5. The method of claim 3, further comprising computing the change based on a Mahalanobis distance.

6. The method of claim 1, wherein the fused lane data includes a position of a center of the lane, and wherein the method further comprises correcting the vehicle pose data based on the map data and the position of the center of the lane.

7. The method of claim 1, wherein the landmark data includes lane markings along the road.

8. The method of claim 1, wherein the landmark data includes lane edges inferred from image data.

9. The method of claim 1, wherein the landmark data includes structures identified next to a lane edge.

10. A system for controlling a vehicle, comprising:
at least one image sensor that generates image data associated with an environment of the vehicle;
a map datastore that stores a lane map; and
a controller configured to, by a processor, receive landmark data obtained from an image sensor of the vehicle, fuse the landmark data with vehicle pose data to produce fused lane data, wherein the fusing is based on a Kalman filter, retrieve map data from the lane map based on the vehicle pose data, selectively updates the lane map based on a change in the fused lane data from the map data; and controls the vehicle based on the updated lane map.

11. The system of claim 10, wherein the fused lane data includes a right lane edge and a left lane edge, and wherein the selectively updating comprises selectively updating a right lane edge and a left lane edge of the lane map based on the right lane edge and the left lane edge of the fused lane data.

12. The system of claim 11, wherein the controller selectively updates by replacing the right lane edge and the left lane edge when the change is greater than a threshold; and fusing the right lane edge and the left lane edge of the lane data with the right lane edge and the left lane edge of the lane map when the change is less than the threshold.

13. The system of claim 12, wherein the controller computes the change based on a hypothesis test.

14. The system of claim 12, wherein the controller computes the change based on a Mahalanobis distance.

15. The system of claim 10, wherein the fused lane data includes a position of a center of the lane, and wherein the controller corrects the vehicle pose data based on the map data and the position of the center of the lane.

16. The system of claim 10, wherein the landmark data includes lane markings along the road.

17. The system of claim 10, wherein the landmark data includes lane edges inferred from image data.

18. The system of claim 10, wherein the landmark data includes structures identified next to a lane edge.

19. The system of claim 10, wherein the controller continuously updates the map during operation of the vehicle.

20. The system of claim 10, wherein the controller generates map error data for graphically displaying the error on the lane map to a user.
